(19) United States
(12) Patent Application Publication
(10) Pub. No.: US 2014/0305257 A1
(43) Pub. Date: Oct. 16, 2014

(54) STEERING HEAD

(71) Applicant: Gebrüder Frei GmbH & Co., Albstadt-Onstmettingen (DE)

(72) Inventors: Thomas Frei, Albstadt (DE); Heribert Schlegel, Balingen (DE)

(73) Assignee: Gebrüder Frei GmbH & Co., Albstadt-Onstmettingen (DE)

(21) Appl. No.: 14/216,126

(22) Filed: Mar. 17, 2014

(30) Foreign Application Priority Data
Apr. 16, 2013 (DE) 10 2013 003 571.4

(51) Int. Cl. G05G 1/10

(52) U.S. Cl. CPC G05G 1/10
USPC 74/551.9

(57) ABSTRACT

A steering head for a walkie/rider truck includes a horn arranged in midsection and connectable to one end of a steering stem. Hand grips configured to control an operation of a drive are arranged on both sides of the horn and extend substantially transversely to the horn, and wing grips configured to control a raising and lowering of a load-carrying member are rotatably mounted on both sides of the horn and defining rotation axes which respectively extend in prolongation of rotation axes of hand grips.

### CROSS-REFERENCES TO RELATED APPLICATIONS

This application claims the priority of German Patent Application, Serial No. 20 2013 003 571.4, filed Apr. 16, 2013, pursuant to 35 U.S.C. 119(a)-(d), the disclosure of which is incorporated herein by reference in its entirety as if fully set forth herein.

### BACKGROUND OF THE INVENTION

The present invention relates to a steering head for a walkie/rider truck.

it would be desirable and advantageous to provide an improved steering head which obviates prior art shortcomings and is simple in structure and which is easy to control and yet is reliable in operation.

### SUMMARY OF THE INVENTION

According to one aspect of the present invention, a steering head for a walkie/rider truck includes a horn arranged in midsection and having one end connectable to a steering stern, hand grips configured to control an operation of a drive, the hand grips arranged on both sides of the horn and extending substantially transversely to the horn, and wing grips configured to control a raising and lowering of a load-carrying member, the wing grips being rotatably mounted on both sides of the horn and defining rotation axes which having one end connectable to a steering stem.

By using the prolongation of the rotation axis of the hand grips as rotation axis of the wing grips, a steering head according to the invention is easy to produce and operation of the steering head is simplified by assigning certain functions to the hand grips and wing grips.

According to another advantageous feature of the present invention, the hand grips can each be configured to implement a forward movement when rotating the hand grip in clockwise direction, and to implement a rearward movement when rotating the hand grip in a counterclockwise direction.

According to another advantageous feature of the present invention, the wing grips can each be configured to implement a lowering of the load-carrying member when rotating the wing grip in clockwise direction, and to implement a raising of the load-carrying member when rotating the wing grip in a counterclockwise direction.

According to another advantageous feature of the present invention, the wing grip can have a diameter which is greater than a diameter of the hand grip. In this way, operation of the steering head is further assisted.

According to another advantageous feature of the present invention, the hand grips can have a cylindrical or bulbed configuration.

According to another advantageous feature of the present invention, the wing grips can have a configuration such as to extend forwards in parallel relation to the horn and rearwards beyond the hand grips, when the wing grips assume an idle position. As a result, the hand grips and also the wing grips have a user-friendly configuration.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a top perspective view of a steering head according to the present invention; and

FIG. 2 is a front view of the steering head of FIG. 1.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

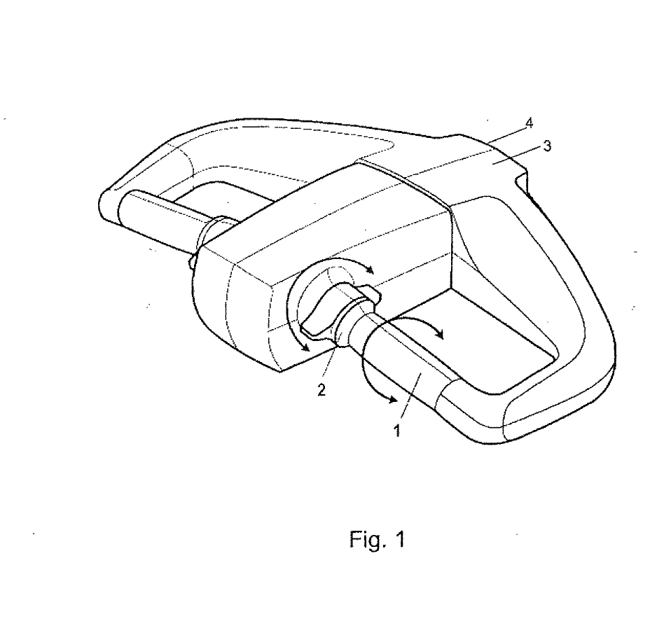

Turning now to the drawing, and in particular to FIG. 1, there is shown a top perspective view of a steering head according to the present invention, having in midsection a horn 3 which has one end 4 connectable to a steering arm (not shown). Hand grips 1 are arranged on both sides of the horn 3 and extending substantially perpendicular to the horn 3. The steering head is further provided with wing grips 2 which are rotatably mounted on the horn 3.

The hand grips 1 are configured to control operation of a drive of the truck, and the wing grips 2 are configured to control a raising and lowering of a load-carrying member (not shown).

A rotation of the hand grips 1 in clockwise direction results in a forward movement and a rotation in the opposite direction, i.e. counterclockwise, results in a rearward movement of the truck. Likewise, a rotation of the wing grips 2 in clockwise direction results in a lowering of the load-carrying member and a rotation in opposite direction, i.e. counterclockwise, results in a raising of the load-carrying member.

Thus, by assigning functions to the hand grips 1 and wing grips 2, the steering head is easy to operate.

As shown in FIG. 1, the wing grips 2 have each a diameter which is greater than a diameter of the hand grip 1. The hand grips 1 have a cylindrical or bulbed configuration and the wing grips 2 are configured in such a way as to extend parallel to the horn 3 in forward direction and beyond the hand grips 1 in rearward direction, when the wing grips 2 assume an idle position.

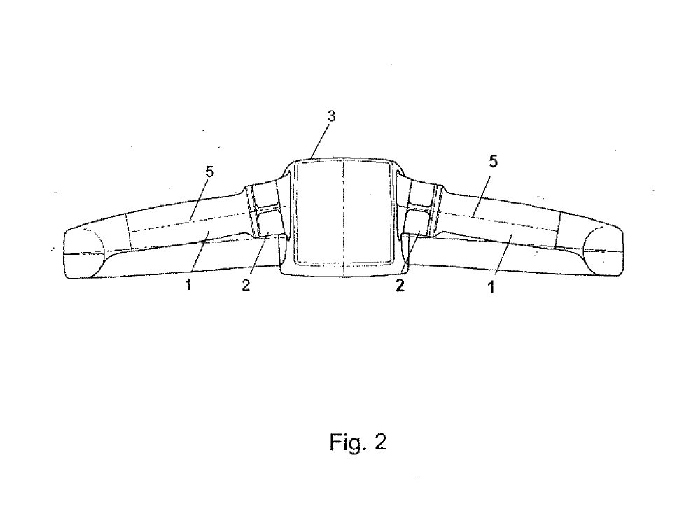

FIG. 2 shows a front view of the steering head, and it can be seen that a prolongation of a rotation axis 5 of the hand grips 1. represents a rotation axis 5 of the wing grips 2. Production of a steering head according to the present invention is hereby simplified.

Overall, the present invention provides a steering head which is simple in structure and easy to operate.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A steering head for a walkie/rider truck, comprising:
a horn arranged in midsection and having one end connectable to a steering stem;
hand grips configured to control an operation of a drive, said hand grips arranged on both sides of the horn and extending substantially transversely to the horn; and
wing grips configured to control a raising and lowering of a load-carrying member, said wing grips being rotatably mounted on both sides of the horn and defining rotation axes which respectively extend in prolongation of rotation axes of the hand grips.

2. The steering head of claim 1, wherein the hand grips are each configured to implement a forward movement when rotating the hand grip in clockwise direction, and to implement a rearward movement when rotating the hand grip in a counterclockwise direction.

3. The steering head of claim 1, wherein the wing grips are each configured to implement a lowering of the load-carrying member when rotating the wing grip in clockwise direction, and to implement a raising of the load-carrying member when rotating the wing grip in a counterclockwise direction.

4. The steering head of claim 1, wherein each said hand grip has a diameter and each said wing grip has a diameter which is greater than the diameter of the hand grip.

5. The steering head of claim 1, wherein the hand grips have a cylindrical or bulbed configuration.

6. The steering head of claim 1, wherein the wing grips have a configuration such as to extend forwards in parallel relation to the horn and rearwards beyond the hand grips, when the wing grips assume an idle position.
